(19) United States
(12) Patent Application Publication
(10) Pub. No.: US 2013/0019856 A1
(43) Pub. Date: Jan. 24, 2013

(54) DEVICE, PACKAGING UNIT AND SYSTEM FOR STEAMING ITEMS TO BE COOKED

(71) Applicant: Leo Buehler, Waedenswil (CH)

(72) Inventor: Leo Buehler, Waedenswil (CH)

(21) Appl. No.: 13/637,725

(22) PCT Filed: Mar. 31, 2011
(86) PCT No.: PCT/IB2011/051379

§ 371 Date: Sep. 27, 2012

(30) Foreign Application Priority Data
Apr. 1, 2010 (CH) 00484/10

(51) Int. Cl. A47J 27/04; A47G 19/02

(52) U.S. Cl. 126/369; 220/575

(57) ABSTRACT

The invention relates to a device (1) for steaming a product to be cooked, in particular food which is contained in an enclosed receptacle (18, 31) of a packaging unit (20), comprising a sealable cooking compartment (2), whereby the packaging unit (20) can be introduced into the cooking compartment (2) and be heated and wherein the device (1) comprises a perforation facility (10) for perforating at least, at least in sections, an outer covering (17) of the receptacle (18, 31) of a packaging unit (20) located in the cooking compartment (2). The invention further comprises a packaging unit (20) for such a device (1) as well as a system comprising such a device (1) and such a packaging unit (20).

The invention relates to a device using a closed receptacle for steaming products contained in a packaging unit, in particular food of the type named in the principal concept of claim 1. The invention further relates to a packaging unit of the type named in the principal concept of claim 11 for use in such a device, and it relates to a system comprising a device and a packaging unit.

Diverse designs of appliances for steaming products are known from the state of the art, for instance hot air steamers. Being predominantly used in the catering industry, a hot air steamer is a professional cooking appliance which, in addition to the function as a fan-assisted oven, can also generate steam or superheated steam. It is suitable, in particular, for steaming vegetables and potatoes, for grilling steak and fish, for baking cakes and desserts. Other familiar devices are pressure cookers whereby boiling water and the product to be cooked form an enclosed unit sealed off from its surroundings. The boiling water causes the pressure to rise within the system. As a rule, the pressure is limited to 2 bars, at which pressure the water boils at 120° C. The higher steam temperature is the cause for the shorter cooking time of pressure-cooked food compared with pressure-free steaming.

The document EP 0 903 096 A2 discloses a device for cooking food in a receptacle resembling a saucepan or frying pan, possibly closed by a lid, such a receptacle being fitted with heated needles which are distributed in the space for receiving the food to be cooked and which are made of heat-conducting material.

Document EP 0 477 168 A2 discloses a cooking appliance for cooking food, in particular meat and fish, comprising a heated container with a hinged lid for receiving a cooking liquid, featuring a perforated insert as base for the food to be cooked.

The above-described devices do not, however, provide for heating food in packages.

Also known are devices for heating meals, where the the food can be heated inside containers suitable for heating up food. Thus, so-called combi-steamers have proved popular which allow the use of superheated air and/or steam during the cooking process. One problem for preparing the food to be cooked, however, is that, due to minimum penetration or unsuitable packaging, the food is often heated unevenly and the result therefore unsatisfactory.

Known from U.S. Pat. No. 4,172,903 A is a packaging unit for use in one of the above-mentioned devices, such packaging unit comprising a dish as receptacle, and an outer covering which provides an air-tight seal for the receptacle of the dish, such covering being detachably fixed to one rim of the dish in such a way that it can be peeled off from the edge by the consumer when the food is cooked.

The disadvantage of such known solutions is that steam-cooking generates condensation resulting in condensate collecting at the base of the dish. The food resting on the floor of the dish is thereby at least partially soaked during cooking. For many consumers this is one of the reasons why they avoid using such products.

The object of the present invention is to create a device, as well as a packaging unit and a system for cooking cookable products which avoid the disadvantages known from the state of the art.

The object is realised by the characteristics of the main claims. Advantageous further developments are detailed in the illustrations and the subordinated patent claims.

According to the invention the device of using an enclosed receptacle for steaming products to be cooked, in particular food, contained in a packaging unit comprises a perforation facility for perforating, at least in sections, an outer covering of the receptacle of a packaging unit which is inside the cooking compartment. The provision of such a perforation facility, which advantageously comprises means for penetrating the packaging, has the advantage of ensuring reliable and uniform heating of the packaging unit and/or the product to be cooked contained in the said packaging unit. For instance, the product to be cooked may, in particular, be a ready meal of a superior quality standard. The packaging unit may, for instance, contain a complete meal with several ingredients or components. The concept of perforation or perforating in this text is understood to mean at least a light piercing of an outer covering of the receptacle. Regular pattern, quantity, form and size of the holes play only minor roles according to the invention, as long as reliable, uniform heating of the item to be cooked can be ensured.

Preferably the device may comprise a base part to hold the cooking compartment and a closing part forming a lid, whereby the closing part is preferably swivel-mounted to the base part and can be basically designed as a hinged lid. This has the advantage that the device can be handled as a single unit and that the lid can simply be flipped open, whenever necessary, e.g. for placing the package into the cooking compartment or taking it out. Such a design of the closing part also facilitates ease of cleaning of the cooking compartment. Another advantage is that the lid which may be hot as a result of the cooking process, will not need to be put down on a surface. The base part must be at least slightly larger than the cooking compartment and can advantageously be fitted with feet or similar so that the device can be placed on a table, a work surface or any other base. The device can, of course display other basic forms different from the configuration described, without deviating from the fundamental inventive idea of the invention.

It is preferred but not compulsory for the perforation facility to be fitted to the closing part, namely on the side facing the product to be cooked. This means that the outer covering of the receiving area is automatically perforated by the lid being closed in direction of the packaging unit. It is, of course, also feasible for further or alternative perforation facilities to be fitted, e.g. to the side walls or the base area of the cooking compartment.

One particular configuration provides for the perforation facility being formed by a multitude of separate needles, preferably of hollow design, whereby, when the closing part is shut, the needles pierce, at least in sections, the outer covering of the receptacle of the packaging unit, right through to the receiving area. The needles may, for example, have round cross sections and cutting edges along their axes, designed so that the needles can reliable pierce the outer covering of the receptacle. The needles may be arranged next to one another e.g. on the closing part in a regular or irregular pattern. Instead of needles, the perforation facility may also encompass pyramidal or knife-like elements, preferably fitted with inlet ducts for conveying steam.

It is preferable, but not compulsory, that the needles are made of a heat-conducting material. The needles may be fitted rigidly or in a detachable, i.e. replaceable manner to the respective structural component. For example, the design can provide for the needles to withdraw or retract automatically when the lid is flipped open.

Another type of embodiment provides for the needles to be, at least in sections, covered with a preferably antiseptic or surface-improving coating in order thereby to protect the cooking compartment and/or the product to be cooked against contamination by undesired, usually harmful, substances. The disinfecting measure can e.g. be in the form of disinfecting the surfaces or the materials.

In preference the device comprises steam generating and conveying means for generating superheated steam and conveying it into the cooking compartment. The conveying means may be conduits, jets or valves, to mention but a few. The device can e.g. be designed as a stand-alone appliance, meaning that the device can carry out its function independently without additional instruments. This has the advantage that the device can be designed as a compact unit of small dimensions requiring a minimum of space at the place of use. In the final analysis, the size, i.e. the dimensions, of the device can be determined by the food or the ready meal or the packaging unit containing the product to be cooked.

The device is preferably heated electrically and is therefore fitted with the necessary plug and cable or similar. Preferably the device will excel in the speed at which it can be ready to use. The consumer is thereby given the opportunity to prepare quickly and easily a high-quality ready meal of his choice.

With one preferred configuration, the cooking compartment and/or the receiving area can be charged with superheated steam via the perforation facility. For example, hot air can be introduced via the needles in the closing part. This would mean that the product to be cooked is instantly charged with superheated steam. The steam may, for example, be emitted in bursts.

Another preferred configuration provides for the steam to be emitted via further or alternative steam outlet elements provided in the a base part and/or closing part. A further likely possibility is a combined operation of perforation facility and steam outlet elements for admitting the steam. For instance, further steam outlet elements, especially valves or similar, may be provided between the needles.

Preferably there can be, in the base and/or in the closing part, at least one area for collecting any condensate occurring during the cooking process, and/or at least one pressure equaliser to compensate the pressure during the cooking process, in particular, at least one relief valve. For example, water reservoirs or containers, or condensate collecting troughs or drains may be provided. The relief valve can protect the device against inadmissable, possibly damaging, pressure increases, because it will syphon off steam into the atmosphere whenever the reaction pressure is exceeded.

By preference the device can comprise a control and/or regulating facility which could be in operative connection with the cooking process sensor fitted inside the cooking compartment, in particular with a temperature and/or pressure sensor, whereby the cooking process is controlled and/or regulated by means of the control and/or regulating unit as a function of predetermined cooking parameters and/or a cooking program and whereby the regulating unit may preferably comprise input means for feeding cooking instructions to determine the cooking parameters or the cooking program. The pressure sensor may, for example, be a pressure sensor to monitor passive pressure, relative pressure, absolute pressure, or something similar.

Another, particularly preferred configuration provides that the input agents are suitable for a coded input of the cooking instructions found on the packaging unit, such as bar codes, symbolic codes or similar. It could, for instance, be possible to install a scanner or scanning facility in or on the device. Required cooking time, temperature range and required operating performance of the device may be automatically transmitted to the device via a line code that may be printed on the packaging unit. Information about minimum shelf life of the product to be cooked could also be recorded and analysed. For the consumer this means a very simple, safe and comfortable way of food handling.

The invention further relates to a packaging unit for use in a device as described above where in at least one receptacle an intermediate layer is provided which is at least permeable to steam, such intermediate layer dividing the minimum of one receptacle into a cooking product receiving area for receiving a product to be cooked, in particular food, and a collecting area for the condensate, whereby the dish features at least one steam escape opening as well as at least one odour retaining facility upstream of the minimum of one steam escape opening.

The intermediate layer ensures that the product to be cooked will be heated evenly and will not come to rest in the condensate that occurs in the course of the cooking process. This guarantees a high quality of the cooked product, especially food, in respect of its consistency and appearance. The odour retaining facility furthermore prevents undesired emissions of odours and contamination in the device for steam-cooking.

The condensate collected in the collecting area can, on the one hand, have a flavor-enhancing effect and, on the other hand, serve as a sauce to be poured over the hot food by the consumer if required.

The outer covering can preferably serve as a lid. Of advantage is if the outer covering is easy to perforate so that the perforation facility of the device can easily penetrate the packaging unit.

During the cooking process, the steam outlet opening ensures that the steam pressure developing in the packaging unit can escape from the receiving area to outside. The packaging unit also features, between the edge of the dish and the outer covering, a bond that opens under pressure, e.g. a fusion bond or adhesive bond. The bond is detachable under pressure and is advantageously so designed that, when the maximum internal pressure or the heating temperature are exceeded, the lid, i.e. the outer covering, becomes detached, at least in sections, from the dish so as to relieve the pressure. This ensures even greater protection against damage due to excess pressure on the packaging unit. The indents created in the outer covering by the perforation facility can, in particular, also serve as pressure relief.

The intermediate layer is preferably provided with several holes to allow the condensate or any liquid occurring during cooking to pass from the cooking product receiving area to the collecting area. The intermediate layer displays advantageously a perforated and/or grid-like structure that is easy to produce. Of further advantage is a design where the openings in the intermediate layer are adapted with regard to size, arrangement and/or quantity to the type of product to be cooked.

It is of advantage that the minimum of one steam outlet opening and also the minimum of one odour retaining facility are located in the collection area, so that all the condensate developing is kept directly in the collection space of the packaging unit. The odour retaining facility comprises advantageously a labyrinth seal. A labyrinth seal in this context is an arrangement of alternating webs which extend the passage of the condensate from the receiving area to the minimum of one steam outlet opening. The resulting cooling of the steam facilitates that sufficient liquid filters out of the steam so that a collection of the said liquid in the collection space is ensured.

Alternatively or supplementary to the foregoing, the minimum of one odour retaining facility comprises a filter element which holds back any odours and any liquid conveyed by the steam. Since such packaging units are normally used only once, inexpensive and simple solutions can be used as filter elements, such as e.g. special made fleece or woven fabric.

Preferably the dish comprises at least one partitioning ridge, dividing the receiving area of the dish into a first receptacle and at least one further receptacle, where the minimum of one partitioning ridge provides an air-tight separation between the first receptacle and the minimum of one other receptacle. The minimum of one partitioning ridge forms a separating element for various sections of the receiving area. The tastes of different food items to be cooked, e.g. meat and garnishes, are therefore not mutually affected. It is of advantage to have an intermediate layer in each receptacle so that each of the receptacles created can enjoy the advantages derived from the provision of a intermediate layer.

The packaging unit may, for example, contain a high-quality ready meal. The packaging unit is preferably so designed that it can without problems be transported, stored and prepared for consumption. It would be an advantage if the packaging unit had a stackable basic form.

The packaging unit can form a peripheral rim that can rest on the edge of the cooking compartment. The advantage of such a packaging unit is the fact that the cooking compartment can be be reliably protected against contamination and similar, since the product inside the packaging unit does not leave the package, and the outer covering, or the lid, of the packaging unit would usually not be removed until the packaging unit has been taken out of and removed from the device. Direct contact of the product with the cooking compartment of the device is avoided due to the packaging unit. The preparation of food is therefore quick and clean, and cleaning the device requires minimum effort.

The packaging unit in combination with the device is for instance ideally suited for preparing individual portions, e.g. for a single person household, without requiring any cooking skills from the consumer.

The packaging unit may, for example, serve as a mere container for heating food. The packaging unit can, for instance, be designed so that the food can be consumed straight from the package, with the packaging unit serving essentially as a plate or serving bowl.

Another particularly advantageous configuration provides that the packaging unit, when placed inside the cooking compartment of the device, can more or less fill the same and virtually finish flush with it. In a preferred version the packaging unit is designed to feature a complementary form to that of the cooking compartment. Complementary form means that cooking compartment and packaging unit display an essentially identical cross-sectional geometry. It is, however, also feasible to design the packaging unit and/or the cooking compartment to allow two or several packaging units of identical or differing sizes to be fitted into and processed simultaneously in the cooking compartment of the device.

The packaging unit may, for example, be made of recyclable material, in particular plastic and/or metal foil.

The invention further relates to a system for steaming products to be cooked, in particular food, comprising a device as described above and a packaging unit as likewise described above with an enclosed receptacle inside it in which a food item or food dish is arranged, whereby the packaging unit can be placed into the cooking compartment of the device, and there be perforated and heated.

Further advantages, more characteristics and details of the invention will be revealed in the description following hereafter which describes an exemplary embodiment of the invention with reference to drawings. The claims and the characteristics referred to in the description can be essential for the invention separately or in any desired combination.

The list of references is part of the disclosure. The figures are described in context and comprehensively. Identical references refer to identical components, references with different indices refer to functionally identical or similar components.

The drawings depict:

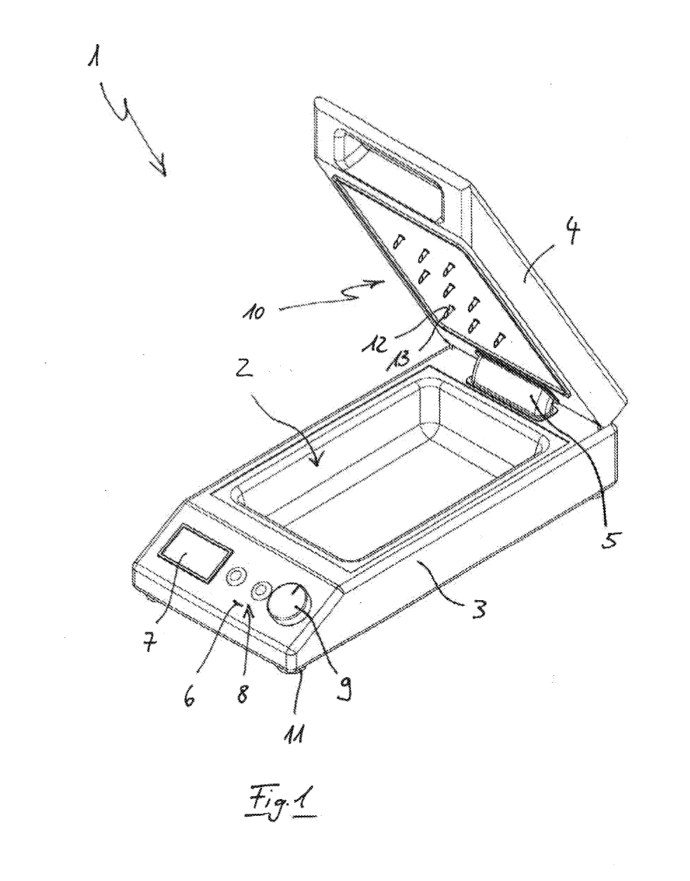

FIG. 1 a perspective representation of a device according to the invention with an open lid without a packaging unit,

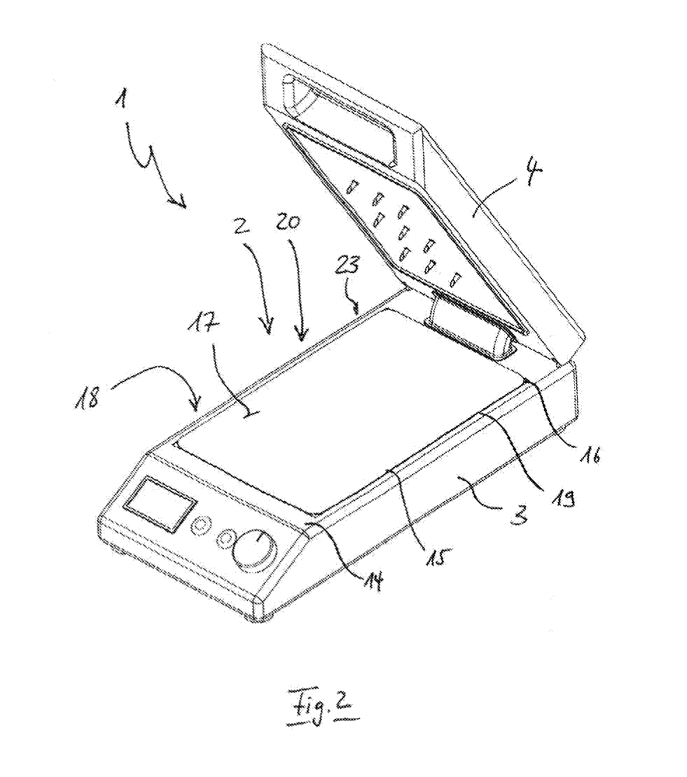

FIG. 2 a perspective representation of the device according to FIG. 1 with an open lid and with a packaging unit placed inside,

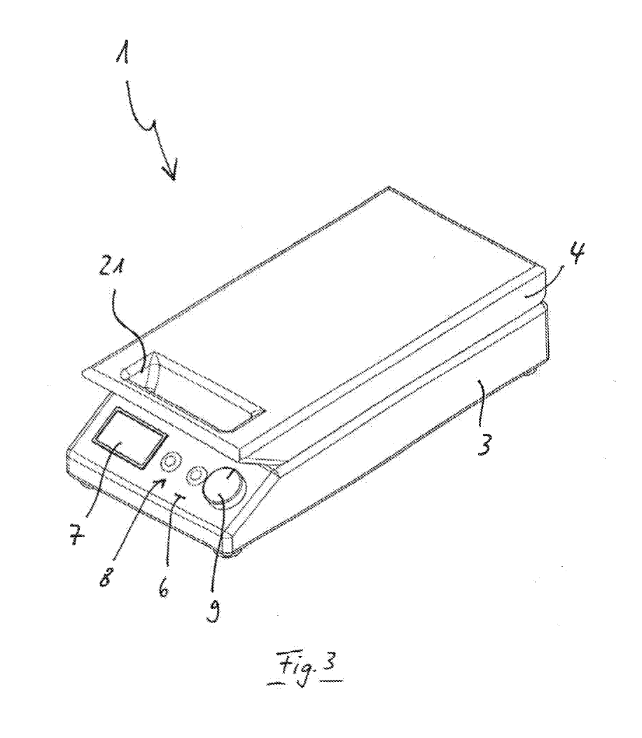

FIG. 3 a perspective representation of the device with a closed lid,

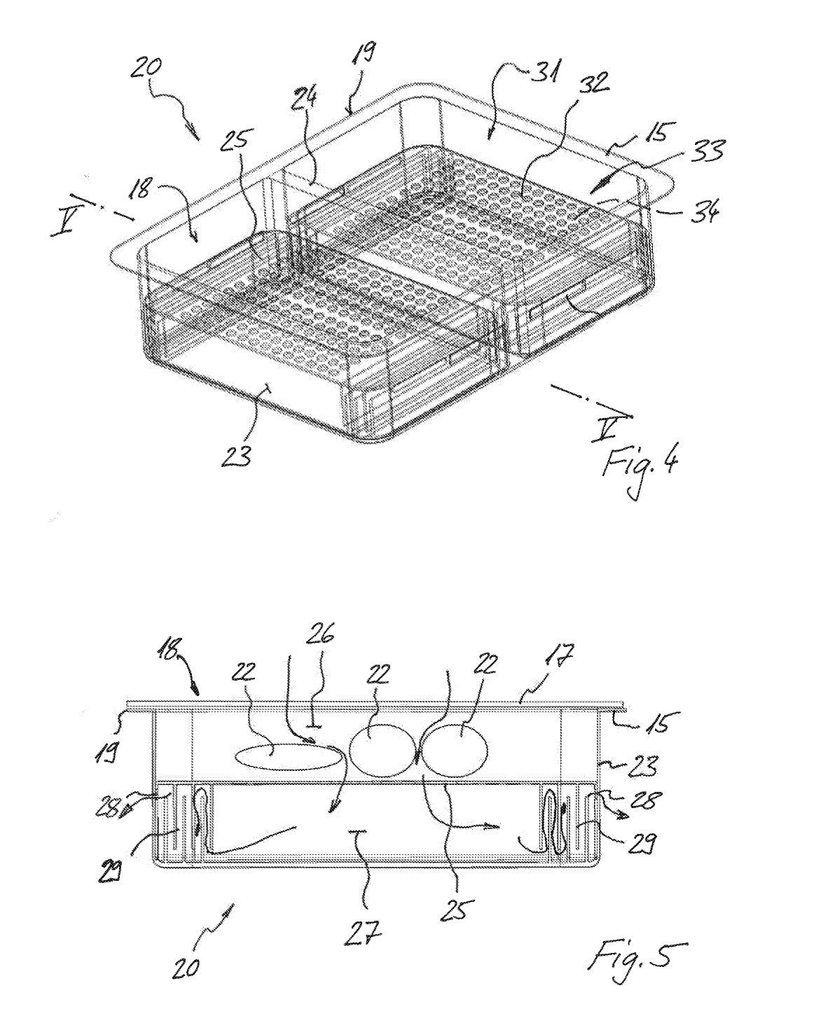

FIG. 4 the packaging unit in perspective individual representation, and

FIG. 5 the packaging unit in cross section along the V-V line in FIG. 4.

FIG. 1 shows a device 1 for steaming products to be cooked, in particular food. The device 1 comprises a cooking compartment 2 as well as a base 3 forming the receptacle for the cooking compartment 2, and a closing part 4 forming a lid, whereby the closing part 4 is hinged to the base 3 by a swivel joint 5 and is configured as a hinged lid. The cooking compartment 2 and the base 3 have a basically rectangular shape.

Height and width of the cooking compartment 2 correspond generally with the height and width of the base 3. The base 3 features a chamfered operating panel 6, where the components of a control and regulating unit are located, in particular a display 7 as well as 2 light elements 8 and a turn switch 9. The control and regulating facility may also comprise a touch screen and may simultaneously serve as display, as indicator and as operating element, so that no separate components are required. Operational mode, operating temperature and the cooking time required can be controlled and regulated via the control and regulating facility. It would be of advantage if the control and regulating facility comprised a timer (e.g. a time clock) to facilitate starting or preheating the device 1 at a predetermined time to allow the product inside the packaging unit 20 to be heated at a later time. The device 1 also features preferably adjustable feet fitted evenly under the base 3.

By shutting the closing part 4, the cooking compartment 2 can be sealed off completely. Raster elements or seals may be fitted to the closing part 4 or the base 3 which would guarantee secure sealing of the device 1 and protect the same from accidental opening during the cooking process.

Fitted to the closing part 4 is a perforation facility 10 consisting of a multitude of separate needles 12. The needles 12 are configured as hollow parts and they each have an essentially round cross section as well as a cutting edge 13 running along its axis. Via the needles 12 the cooking compartment 2 and the product 22 to be cooked inside a packaging unit can be charged with superheated steam.

FIG. 2 shows the device 1 with a packaging unit 20 placed inside the cooking compartment 2. The packaging unit 20 finishes essentially flush with the upper edge 14 of the base 3 and its peripheral rim 15 rests on the peripheral area 16 of the cooking compartment 2. The peripheral rim 15 of the packaging unit is located slightly lower in the peripheral area of the cooking compartment 2.

The perforation facility 10 is designed so that the needles 12 safely penetrate the outer covering 17 of the receptacles 18 and 31—not shown here—of the packaging unit 20 located in the cooking compartment 2. By preference, the needles 12 of the perforation facility 10 do not come into contact with the product 22 located in the receptacles 18 and 31. The outer covering 17 of the packaging unit 20 is designed so that a simple penetration of the needles 12 into the receptacles 18 and 31 can take place as soon as the closing part 4 has reached its closed position. The packaging unit 20 and the cooking compartment 2 display an essentially identical cross-sectional geometry, i.e. they feature essentially complementary forms.

After the cooking process the perforated outer covering 17 can be detached from the container edge 19 of the packaging unit 20. It could be arranged, for example, that below the perforated outer covering 17 there is a second different foil or cover or something like it. For example, it could be arranged that the perforation facility 10 only pierces the first outer covering 17 but not a second foil positioned underneath.

FIG. 3 shows the device 1 with a shut closing part 4, with the closing part 4 completely covering, i.e. sealing the cooking compartment. The closing part 4 features an integrated handle 21, with the handle area 21 being similarly inclined as the operating panel 6 on the base 3. The closing part 4 is slightly shorter than the base 3 to ensure, even in the closed state, a clear vision of, and access to, the display 7, the indicator lights 8 and the turn switch 9.

FIGS. 4 and 5 show the packaging unit 20 in detail. The packaging unit 20 is configured as a dish to eat out of, which can be filled with a ready meal as product 22 to be cooked. The packaging unit 20 comprises a bowl 23 in which a partitioning ridge 24 is provided as separating element, so that the dish 23 comprises a first receptacle 18 and a second receptacle 31. The receptacles 18 and 31 in this example share a single outer covering 17 providing airtight sealing, the said outer covering 17 serving as a lid for the dish 23. Alternatively, the receptacles 18 and 31 may be sealed by two separate outer covers. In another variation, although not the final one, the receptacles 18 and 31 are likewise enclosed by a single outer covering 17 but this design advantageously features a marked separating line preferably over the partitioning ridge 24, so that each of the two receptacles 18 and 31 can be opened individually and separately by the consumer.

The perforation of the outer covering 17 and the superheated steam administered via the needles 12 of the perforation facility 10 have the effect that the first receptacle 18 and the second receptacle 31 are charged with superheated steam. The packaging unit 20 can be completely recycled after the cooked product 22 has been consumed. The outer covering 17 may for example be a transparent cover. In one variation the device 1 for steaming the product 22 to be cooked is so designed or controlled that the two receptacles 18 and 31 can be subjected to superheated steam at different rates. This facilitates a simple way to allow for products requiring varying cooking times to be cooked or heated in a device 1 to a high standard of quality in taste.

The packaging unit 20 has a larger peripheral area 15 compared with the receptacle 18 or the dish 23, with the peripheral area 15 serving, on the one hand, as a carrying and handling aid and, on the other, as the area for fitting the packet onto the peripheral rim 16 of the cooking compartment 2. By preference the heating process can be such that only the product to be cooked 22 and the dish 23, but not the rim 15 will be heated, to ensure that extracting the packaging unit 20 from the cooking compartment 2 of the device 1 is made as comfortable as possible. As soon as the consumer has heated his ready meal in the device 1, the warming temperature leads to a softening of the fusion bonded adhesive by which the outer covering 17 is attached to the dish 23, so that the outer covering 17 can be completely peeled off from the dish rim 19 without much effort.

In each of the receptacles 18 and 31 there is an intermediate layer 25 and 32, respectively, provided with a number of holes, which in this exemplary embodiment has a perforated structure. The intermediate layer 25 in the first receptacle 18 divides the same into a product receiving area 26 for receiving the product 22 to be cooked and a collecting area 27 for the condensate. The intermediate layer 32 in the second receiving area 31 divides the same correspondingly into a product receiving area 33 for receiving the product 22 to be cooked and a collecting area 34 for the condensate. Hereinafter we shall only refer to the first receptacle 18, with the details applying correspondingly to the second receptacle 31.

The first receptacle 18 features, in the collecting area 27 on each of two facing sides of the dish 23, a steam outlet opening 28 as well as, preceding the steam outlet opening 28, an odour retaining facility in the form of a labyrinth seal 29.

The superheated steam entering the receptacle 18 (here shown as arrows) swills around the product 22 to be cooked inside the product receiving area 26 causing this to be heated or warmed up. Subsequently, the superheated steam passes through the perforated intermediate layer 25 into the collection area 27 where any accumulated condensate and/or liquid separated from the product 22 during the cooking process is collected. The steam remaining in the collection area 27 exits through the steam outlet opening 28, having first to pass through the labyrith seal 29. In the course of this passage any liquid still carried along by the steam will precipitate and remain in the collection area 27. Together with the condensate, the smell and taste of the cooked product 22 also remains in the packaging unit 20. Besides, the device 1 for steam cooking is not contaminated by the steam escaping from the packaging unit 20.

List of references

| | |
|---|---|
| 1 | device |
| 2 | cooking compartment |
| 3 | base |
| 4 | closing part |
| 5 | swivel joint |
| 6 | operating panel |
| 7 | display |
| 8 | lighting element |
| 9 | turn switch |
| 10 | perforation facility |
| 11 | feet |
| 12 | needles |
| 13 | Cutting edge |
| 14 | top surface of base |
| 15 | peripheral area of |
| | packaging unit |
| 16 | peripheral area of |
| | cooking compartment |
| 17 | outer covering |
| 18 | 1. receptacle of 23 |
| 19 | rim of dish |
| 20 | packaging unit |
| 21 | handle area |
| 22 | product to be cooked |
| 23 | dish |
| 24 | Partitioning ridge |
| 25 | intermediate layer of 18 |
| 26 | product receiving area of 18 |
| 27 | collection chamber of 18 |
| 28 | steam outlet opening of 27 |
| 29 | Labyrinth seal |
| 31 | 2. receptacle of 23 |
| 32 | intermediate layer of 31 |
| 33 | product receiving area of 31 |
| 34 | collection area of 31 |

1-15. (canceled)

16. A device (1) using an enclosed receptacle (1 8, 31) for steaming a product (22) to be cooked, in particular food, contained in a packaging unit (20), comprising a sealable cooking compartment (2), whereby the packaging unit (20) can be introduced into the cooking compartment (2) and be heated there, characterized by the device (1) comprising a perforation facility (10) for perforating, at least in sections, an outer covering (1 7) of the receptacle (1 8, 31) of a packaging unit (20).

17. A device according to claim 16 characterized by the device (1) featuring a base (3) holding the cooking compartment (2) and a closing part (4) forming a lid, with the closing part (4) preferably being swivel-mounted to the base (3) and being essentially configured as a hinged lid.

18. A device according to claim 17 characterized by the perforation facility (10) being fitted to the closing part (4) on the side facing the product (22) to be cooked.

19. A device according to claim 17 characterized by the perforation facility (10) being formed by a multitude of separate needles (12) advantageously designed as essentially hollow bodies, whereby, with the closing part (4) being shut, the needles (12) perforate, at least in sections, the outer covering (1 7) of the receptacle (1 8) of a packaging unit (20) right down into the receptacle (18, 31).

20. A device according to claim 19 characterized by the needles (12) being, at least in sections, covered with a preferably antiseptic or surface-improving coating in order to protect the cooking compartment (2) and/or the product (22) to be cooked against contamination.

21. A device according to claim 16 characterized by the device (1) comprising a steam generating and conveying facility for generating and conveying superheated steam into the cooking compartment (2) and/or the receptacle (1 8, 31).

22. A device according to claim 16 characterized by the fact that the cooking compartment (2) and/or the receptacle (18, 31) can be charged with superheated steam via the perforation facility (10) and/or the steam outlet elements provided in the base (3) and/or on the closing part (4).

23. A device according to claim 17 characterized by the base (3) and/or the closing part (4) comprising at least one receptacle (18, 31) for collecting the condensate developing during the cooking process, and at least one pressure compensation facility for equalising the pressure during the cooking process, in particular, at least one relief valve.

24. A device according to claim 16 characterized by the device (1) featuring a control and/or regulating unit which is in operative connection with the cooking process sensor fitted inside the cooking compartment (2), in particular with a temperature and/or pressure sensor, whereby the cooking process is controlled and/or regulated by means of the control and/or regulating unit as a function of predetermined cooking parameters and/or a cooking program, and whereby the regulating unit may preferably comprise input means for conveying cooking instructions to determine the cooking parameters or the cooking program.

25. A device according to claim 24 characterized by the input means being suitable for a coded input of cooking instructions found on the packaging unit (20) in the form of bar codes, symbolic codes or similar.

26. A packaging unit for use in a device according to claim 16 comprising a dish (23) which forms at least one receptacle (18, 31) and features an outer covering (17) which provides airtight sealing for the minimum of one one receptacle (18, 31) of the dish (23) and which is detachably fixed to the rim (19) of the dish so that after completed cooking it can be peeled off from the rim (19) by the user characterized by the fact that in the minimum of one receptacle (18, 31) an at least one steam-permeable intermediate layer (25, 32) is provided which divides the minimum of one receptacle (18, 31) into a product receiving area (26, 33) for receiving a product (22) to be cooked, in particular food, and a collection area (27, 34) for the condensate, whereby the dish (23) features at least one steam outlet opening (28) as well as, preceding the minimum of one steam outlet opening (28), at least one odour retaining facility (29).

27. A packaging unit according to claim 26 characterized by the intermediate layer (25, 32) featuring a number of openings and preferably having a perforated and/or grid-like structure.

28. A packaging unit according to claim 26 characterized by the minimum of one steam outlet opening (28) and advantageously also at least one odour retaining facility being fitted in the collection area (27, 34), with the odour retaining facility beneficially comprising a labyrinth seal (29) and/or a filter element.

29. A packaging unit according to claim 26 characterized by there being at least one partitioning ridge (24) in the dish (23) which divides the receptacle (18, 31) of the dish (23) into a first receptacle (18) and at least one other receptacle (31), whereby the minimum of one partitioning ridge (24) advantageously provides an air-tight separation between the first receptacle (18) and the minimum of one other receptacle (31) and where advantageously there is an intermediate layer (25, 32) provided in each of the receptacles (18, 31).

30. A system for steaming a product to be cooked, in particular food, comprising a device (1) according to claim 16 with an enclosed cooking compartment (2) and a packaging unit (20) according to one of the claims 11 to 14 with an essentially enclosed receptacle (18, 31), which contains a product to be cooked (22), in particular food or a meal, whereby the packaging unit (20) can be introduced into the cooking compartment (2) of the device (1) and there can be perforated and heated.
